(19) United States
(12) Patent Application Publication
(10) Pub. No.: US 2007/0230052 A1
(43) Pub. Date: Oct. 4, 2007

(54) Perpendicular magnetic recording medium and magnetic storage device

(75) Inventors: Antony Ajan, Kawasaki (JP); Toshio Sugimoto, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/486,297

(22) Filed: Jul. 14, 2006

(30) Foreign Application Priority Data
Mar. 31, 2006 (JP) 2006-100593

(51) Int. Cl. G11B 5/74; G11B 5/66

(52) U.S. Cl. 360/131; 428/828.1; 428/829; 428/831.2

(57) ABSTRACT

A perpendicular magnetic recording medium is disclosed that is able to prevent the Wide Area Track Erasure phenomenon from occurring and is capable of high density recording. The perpendicular magnetic recording medium includes a substrate; a soft-magnetic backup layer on the substrate; a separation layer on the soft-magnetic backup layer and formed from a non-magnetic material; a magnetic flux control layer on the separation layer; and a recording layer on the magnetic flux control layer having an easy axis of magnetization perpendicular to the surface of the substrate. The magnetic flux control layer is formed from a poly-crystal ferromagnetic material having an easy axis of magnetization perpendicular to the surface of the substrate.

### CROSS-REFERENCE TO RELATED APPLICATION

This patent application is based on Japanese Priority Patent Application No. 2006-100593 filed on Mar. 31, 2006, the entire contents of which are hereby incorporated by reference.

### BACKGROUND OF THE INVENTION

1. Field of the Invention

The present invention relates to a perpendicular magnetic recording medium and a magnetic storage device.

2. Description of the Related Art

Magnetic storage devices are widely used in various apparatuses from large scale systems to computers for personal use and communication devices. In all kinds of applications of the magnetic storage devices, it is required to further increase the recording density and the data transmission speed.

In recent years, in an in-plane recording technique, which is a primary magnetic recording method at present, a recording layer having a high coercive force (namely, having high thermal stability of residual magnetization) is employed in order to prevent loss of information recorded at a high recording density. In order to further increase the recording density, it is necessary to further increase the coercive force, and accordingly, it is necessary to increase the strength of the magnetic field for recording of a magnetic recording head. For this purpose, it is required to use a soft magnetic material having a high saturation magnetic flux density in the magnetic pole of the magnetic head. However, such a soft magnetic material is not readily available; thus, it is difficult to increase the recording density of a magnetic recording device.

On the other hand, in a perpendicular magnetic recording technique, since the recording layer of a magnetic recording medium is magnetized in a direction perpendicular to a surface of a substrate, the recorded information can hardly be lost compared to the in-plane recording technique. For this reason, it is possible to obtain a higher recording density than the in-plane recording technique.

In a perpendicular magnetic recording medium, a backup layer formed from a soft magnetic material is applied on a substrate, and on the backup layer a recording layer is stacked. When recording information in the perpendicular magnetic recording medium, the magnetic field of the magnetic head is applied perpendicularly on the film surface of the recording layer, and the magnetic field returns to the magnetic head by passing through the soft magnetic material backup layer. The soft magnetic material backup layer forms a pair with the magnetic head to absorb and expel the magnetic field. In the soft magnetic material backup layer, if a magnetic wall is formed therein, the magnetic field leaking from the magnetic wall may be detected by a reproduction head, and this causes noise spikes, and may cause errors.

To reduce the noise spikes, it is proposed that the soft magnetic material backup layer be formed by stacking two soft magnetic material layers with a non-magnetic layer in between so as to form a magnetic structure with the two soft magnetic material layers being coupled by anti-ferromagnetic coupling. For example, Japanese Laid-Open Patent Application No. 2001-155322, Japanese Laid-Open Patent Application No. 2002-358618, and Japanese Laid-Open Patent Application No. 2001-331920 disclose inventions related to this technique.

In such a magnetic structure, the magnetization in one soft magnetic material layer is anti-parallel to the magnetization in the other soft magnetic material layer; thus, the magnetic field leakages from the magnetic walls of respective soft magnetic material layers cancel out each other, and this prevents generation of the noise spike. In addition, since it is possible to prevent formation of magnetic domains, amorphous materials can be used to form the soft magnetic material layers.

However, in the perpendicular magnetic recording medium, a so-called Wide Area Track Erasure (WATER) phenomenon arises. The Wide Area Track Erasure is a phenomenon in which when information is repeatedly recorded in the same track, information from the recorded track to tracks a few microns apart disappears.

Specifically, when the recording magnetic field from the magnetic pole of the recording head passes through the recording layer, and is absorbed by the soft magnetic backup layer, the recording magnetic field spreads in the in-plane direction of the perpendicular magnetic recording medium, thus a weak magnetic field is also applied to the area adjacent to the recorded track. With the weak magnetic field being applied repeatedly, the residual magnetization in this area is reduced gradually, and eventually, causing reproduction errors.

When the Wide Area Track Erasure phenomenon arises, the recorded information is lost, and the long-term reliability of the perpendicular magnetic recording medium declines.

### SUMMARY OF THE INVENTION

The present invention may solve one or more of the problems of the related art.

A preferred embodiment of the present invention may provide a perpendicular magnetic recording medium and a magnetic storage device able to prevent the Wide Area Track Erasure phenomenon from occurring and capable of high density recording.

According to a first aspect of the present invention, there is provided a perpendicular magnetic recording medium, comprising:

a substrate;

a soft-magnetic backup layer on the substrate;

a separation layer on the soft-magnetic backup layer and formed from a non-magnetic material;

a magnetic flux control layer on the separation layer; and

a recording layer on the magnetic flux control layer, said recording layer having an easy axis of magnetization perpendicular to the surface of the substrate;

wherein

the magnetic flux control layer is formed from a poly-crystal ferromagnetic material having an easy axis of magnetization perpendicular to the surface of the substrate.

According to the present invention, since the magnetic flux control layer has an easy axis of magnetization perpendicular to the surface of the substrate, the recording magnetic field from the recording element is absorbed perpendicularly by the magnetic flux control layer via the recording layer. Thus, it is possible to prevent transverse spread of the recording magnetic field.

Since the magnetic flux control layer is formed from a crystal material, it is possible to set the saturation magnetic flux density of the magnetic flux control layer to be higher than that of an amorphous material; this further prevents the transverse spread of the recording magnetic field, and prevents the Wide Area Track Erasure phenomenon from occurring.

Further, since the magnetic flux control layer is formed from a crystal material, it is possible to improve the crystallinity and the crystalline alignment of the recording layer on the magnetic flux control layer, and this improves the magnetic property and the recording and reproduction performance of the recording layer, and enabling high density recording in the perpendicular magnetic recording medium.

As an embodiment, the magnetic flux control layer may include a first magnetic layer, a first non-magnetic coupling layer, and a second magnetic layer stacked on the separation layer in order, and the first magnetic layer and the second magnetic layer may be formed from a poly-crystal ferromagnetic material having an easy axis of magnetization perpendicular to the substrate, and a magnetization of the first magnetic layer and a magnetization of the second magnetic layer are aligned in a direction perpendicular to the substrate and are coupled with each other by anti-ferromagnetic coupling.

According to the present invention, since the first magnetic layer and the second magnetic layer of the magnetic flux control layer are formed from a crystal material, it is possible to improve the crystallinity and the crystalline alignment of the recording layer on the magnetic flux control layer, and this improves the magnetic property and the recording and reproduction performance of the recording layer.

In addition, since the crystal grains of the first magnetic layer and the crystal grains of the second magnetic layer are coupled with each other by anti-ferromagnetic coupling, the magnetic field leakages from the first magnetic layer and the second magnetic layer cancel out each other. Thus, it is possible to reduce the magnetic field leakage from the magnetic flux control layer, and prevent noise from being detected by the reproduction element; as a result, the SN (Signal-to-Noise) ratio of the perpendicular magnetic recording medium can be improved. Consequently, it is possible to perform high density recording in the perpendicular magnetic recording medium.

In addition, since the first magnetic layer and the second magnetic layer of the magnetic flux control layer have easy axes of magnetization perpendicular to the substrate, the recording magnetic field is absorbed perpendicularly by the magnetic flux control layer. Thus, it is possible to prevent transverse spread of the recording magnetic field, and further prevents the Wide Area Track Erasure phenomenon from occurring.

According to a second aspect of the present invention, there is provided a magnetic storage device, comprising:

a recording and reproduction unit having a magnetic head; and

a perpendicular magnetic recording medium,

wherein

the perpendicular magnetic recording medium includes

a substrate;

a soft-magnetic backup layer on the substrate;

a separation layer on the soft-magnetic backup layer and formed from a non-magnetic material;

a magnetic flux control layer on the separation layer; and

a recording layer on the magnetic flux control layer, said recording layer having an easy axis of magnetization perpendicular to the surface of the substrate;

wherein
the magnetic flux control layer is formed from a poly-crystal ferromagnetic material having an easy axis of magnetization perpendicular to the surface of the substrate.

According to the present invention, it is possible to provide a magnetic storage device capable of high density recording, and has good long-term reliability.

These and other objects, features, and advantages of the present invention will become more apparent from the following detailed description of the preferred embodiments given with reference to the accompanying drawings.

### BRIEF DESCRIPTION OF THE DRAWINGS

FIG. 1 is a schematic cross-sectional view illustrating an example of a perpendicular magnetic recording medium according to a first embodiment of the present invention;

FIG. 2A and FIG. 2B are plan views illustrating crystalline states and magnetizations of the crystal magnetic layers 19 and 21 of the perpendicular magnetic recording medium 10 according to the first embodiment of the present invention;

FIG. 3 is a schematic cross-sectional view illustrating another example of a perpendicular magnetic recording medium according to the first embodiment of the present invention;

FIG. 4 is a schematic cross-sectional view illustrating another example of a perpendicular magnetic recording medium according to the first embodiment of the present invention;

FIG. 5 is a schematic cross-sectional view illustrating another example of a perpendicular magnetic recording medium according to the first embodiment of the present invention;

FIG. 6 shows a hysteresis loop of the perpendicular magnetic recording medium of the example 1;

FIG. 7 shows experimental results of the relation between the perpendicular coercive force and the film thickness of the crystal magnetic layer;

FIG. 8 shows experimental results of the relation between the nucleus formation magnetic field and the film thickness of the crystal magnetic layer;

FIG. 9 shows experimental results of the relation between the overwrite property and the film thickness of the crystal magnetic layer;

FIG. 10 is a table showing properties of the perpendicular magnetic recording media of the example 3 and the example 4; and

FIG. 11 is a schematic view of a principal portion of a magnetic storage device according to a second embodiment of the present invention.

### DESCRIPTION OF THE PREFERRED EMBODIMENTS

Below, preferred embodiments of the present invention are explained with reference to the accompanying drawings.

### First Embodiment

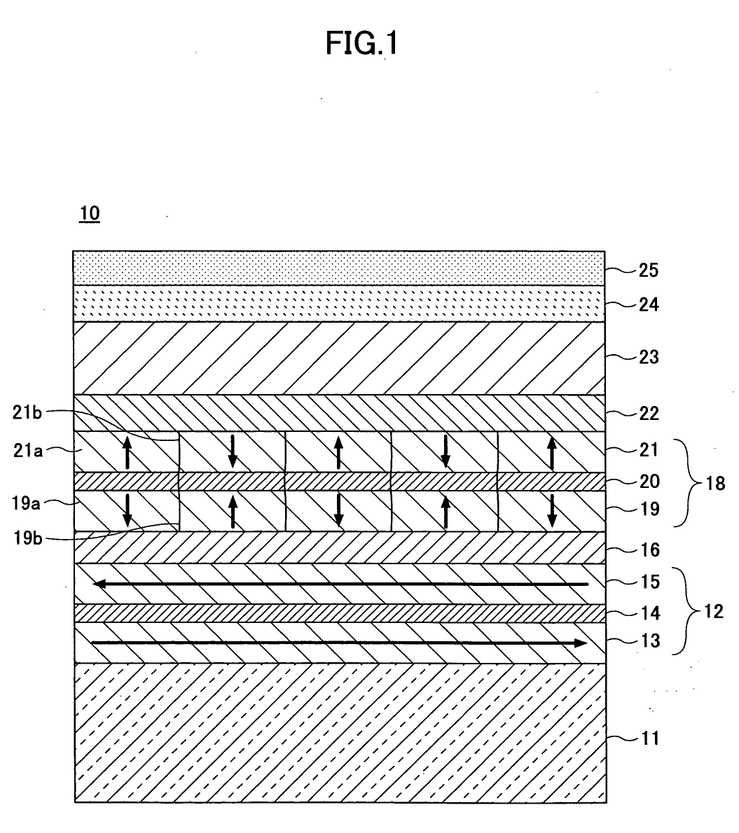

FIG. 1 is a schematic cross-sectional view illustrating an example of a perpendicular magnetic recording medium according to a first embodiment of the present invention.

As illustrated in FIG. 1, a perpendicular magnetic recording medium 10 includes a substrate 11, and a backup stack structure 12, a separation layer 16, a magnetic flux control stack structure 18, an intermediate layer 22, a recording layer 23, a protection film 24, and a lubrication layer 25 stacked on the substrate 11 in order.

The substrate 11, for example, may be a plastic substrate, a crystallized glass substrate, a strengthened glass substrate, a silicon substrate, or an aluminum alloy substrate.

When the perpendicular magnetic recording medium 10 is a magnetic disk, the substrate 11 has a disk shape. When the perpendicular magnetic recording medium 10 is a magnetic tape, the substrate 11 may be formed by a PET (polyethylene terephthalate) film, a PEN (polyethylene naphthalate) film, or heat-resistant polyimide (PI).

The backup stack structure 12 includes an amorphous soft magnetic layer 13 and an amorphous soft magnetic layer 15, and a non-magnetic coupling layer 14 in between. The magnetizations of the amorphous soft magnetic layer 13 and the amorphous soft magnetic layer 15 are coupled by anti-ferromagnetic coupling through the non-magnetic coupling layer 14.

For example, each of the amorphous soft magnetic layer 13 and the amorphous soft magnetic layer 15, is 50 nm-2 μm in thickness, and is formed from an amorphous soft material including at least one of Fe, Co, Ni, Al, Si, Ta, Ti, Zr, Hf, V, Nb, C, and B. More specifically, the amorphous soft magnetic layer 13 and the amorphous soft magnetic layer 15 may be formed from materials such as FeSi, FeAlSi, FeTaC, CoNbZr, CoCrNb, CoFeB, and NiFeNb.

When the substrate 11 is a disk, preferably, the easy axes of magnetizations of the amorphous soft magnetic layer 13 and the amorphous soft magnetic layer 15 are in the radial direction of the substrate 11. Due to this, in a residual magnetization state, the direction of the magnetization of the amorphous soft magnetic layer 13 and the direction of the magnetization of the amorphous soft magnetic layer 15 are toward the center of the substrate 11 and toward the periphery of the substrate 11, respectively, or to the contrary.

Due to the above structure, it is possible to prevent formation of magnetic domains in the amorphous soft magnetic layer 13 and the amorphous soft magnetic layer 15, and prevent magnetic field leakage from the interfaces of the magnetic domains.

Preferably, the amorphous soft magnetic layer 13 and the amorphous soft magnetic layer 15 may be formed from soft magnetic materials having the same composition, and the amorphous soft magnetic layer 13 and the amorphous soft magnetic layer 15 have comparable thicknesses. Due to this, the magnetic field leakages from the amorphous soft magnetic layer 13 and the amorphous soft magnetic layer 15 cancel out each other, and this prevents noise from being received by the reproduction element of the magnetic head. Alternatively, the amorphous soft magnetic layer 13 and the amorphous soft magnetic layer 15 may be formed from soft magnetic materials having compositions different from each other.

The non-magnetic coupling layer 14 may be formed from a non-magnetic material including one of Ru, Cu, Cr, Rh, Ir, Ru alloys, Rh alloys, and Ir alloys. Preferably, the Ru alloy non-magnetic materials are alloys of Ru with one of Co, Cr, Fe, Ni, and Mn.

The thickness of the non-magnetic coupling layer 14 is in an appropriate range so that the amorphous soft magnetic layer 13 and the amorphous soft magnetic layer 15 are coupled by anti-ferromagnetic exchange coupling. For example, the thickness of the non-magnetic coupling layer 14 is in a range from 0.4 nm to 1.5 nm.

In the backup stack structure 12, a stack layer including a non-magnetic coupling layer and an amorphous soft magnetic layer may be disposed on the amorphous soft magnetic layer 15. However, in this case, it is preferable that the net magnetization of the entire backup stack structure 12 be nearly zero. Due to this, it is possible to reduce magnetic flux leakage to be nearly zero.

The separation layer 16, for example, is 2.0 nm-10 nm in thickness, and may be formed from an amorphous non-magnetic material including at least one of Ta, Ti, C, Mo, W, Re, Os, Hf, Mg, and Pt. Because the separation layer 16 is amorphous, it does not influence the crystal alignment of the crystal magnetic layer 19 of the magnetic flux control stack structure 18. Due to this, the crystal magnetic layer 19 can be easily aligned in a self-organizing manner, and this improves the crystal alignment of the crystal magnetic layer 19.

In addition, the separation layer 16 further makes the distribution of diameters of the crystal grains 19a in the crystal magnetic layer 19 uniform. Further, since the separation layer 16 is non-magnetic, it prevents magnetic coupling between the amorphous soft magnetic layer 15 and the crystal magnetic layer 19.

The magnetic flux control stack structure 18 includes the crystal magnetic layer 19 and a crystal magnetic layer 21, and a non-magnetic coupling layer 20 in between. Each of the crystal magnetic layer 19 and the crystal magnetic layer 21 is formed from a crystal ferromagnetic material. Each of the crystal magnetic layer 19 and the crystal magnetic layer 21 includes plural crystal grains 19a and 21a, and the crystal grains 19a and 21a are in close contact with each other via granular boundaries 19b and 21b.

The easy axes of magnetizations of crystal grains 19a and 21a are along the arrow directions in FIG. 1, namely, are aligned to be perpendicular to the substrate, and the crystal magnetic layer 19 and the crystal magnetic layer 21 are coupled with each other by anti-ferromagnetic coupling through the non-magnetic coupling layer 20.

In FIG. 1, the orientations of the arrows indicate the orientations of the residual magnetizations, that is, when an external magnetic field is not applied.

Preferably, each of the crystal magnetic layer 19 and the crystal magnetic layer 21 is formed from Co or Co—X1 alloys having a hcp crystalline structure, where X1 represents at least one of Ni, Fe, Cr, Pt, B, Ta, Cu, W, Mo, and Nb. The alloy Co—X1 may include one of CoCr, CoPt, CoCrTa, CoCrPt, and CoCrPt-M, where, M represents at least one of B, Ta, Cu, W, Mo, and Nb. The above crystal ferromagnetic materials of the crystal magnetic layer 19 and the crystal magnetic layer 21 can be formed by aligning the easy axis of magnetization in a direction perpendicular to the substrate on the self-organizing separation layer 16.

Preferably, the perpendicular coercive force of the crystal magnetic layer 19 and the crystal magnetic layer 21 is less than the perpendicular coercive force of the recording layer 23. Further, in order that magnetization reversal of the crystal magnetic layer 19 and the crystal magnetic layer 21 occurs at relatively low recording magnetic field, it is preferable to set the perpendicular coercive force of the crystal magnetic layer 19 and the crystal magnetic layer 21 less than 5000 Oe, more preferably, to be near 0 Oe.

The perpendicular coercive force is a coercive force calculated from a hysteresis loop of a magnetization or a Kerr rotation angle when applying a magnetic field in a direction perpendicular to the substrate.

From the point of view of easy magnetization reversal of the crystal magnetic layer 19 and the crystal magnetic layer 21, it is preferable that the thickness of each of the crystal magnetic layer 19 and the crystal magnetic layer 21 be in the range from 1 nm to 25 nm.

The non-magnetic coupling layer 20 may be formed from non-magnetic transition materials including one of Ru, Cu, Cr, Rh, Ir, Ru alloys, Rh alloys, and Ir alloys. The Ru alloys can be obtained by adding at least one of Co, Cr, Fe, Ni, and Mn, or alloys of them, to Ru element. The thickness of the non-magnetic coupling layer 20 is in an appropriate range so that the crystal magnetic layer 19 and the crystal magnetic layer 21 are coupled by anti-ferromagnetic exchange coupling. For example, the thickness of the non-magnetic coupling layer 20 is in a range from 0.4 nm to 2.1 nm.

When the non-magnetic coupling layer 20 is formed from a Ru film or a Ru alloy film, preferably, the thickness of the non-magnetic coupling layer 20 is in a range from 0.4 nm to 0.9 nm. When the non-magnetic coupling layer 20 is formed from a Cr film, preferably, the thickness of the non-magnetic coupling layer 20 is in a range from 0.6 nm to 1.2 nm. When the non-magnetic coupling layer 20 is formed from a Cu film, preferably, the thickness of the non-magnetic coupling layer 20 is in a range from 0.8 nm to 2.1 nm.

With the thickness of the non-magnetic coupling layer 20 in the above range, it is possible to enhance the exchange coupling magnetic field between the crystal magnetic layer 19 and the crystal magnetic layer 21. Due to this, it is possible to prevent the anti-parallel state of the magnetizations of the crystal magnetic layer 19 and the crystal magnetic layer 21 from being destroyed, and thus to prevent leakage of the magnetic field.

It should be noted that the dependence of the ranges of the thickness on the constituent elements of the non-magnetic coupling layer 20 is also applicable to the non-magnetic coupling layer 14.

If the residual magnetization and the thickness of the crystal magnetic layer 19 are denoted by Mr1 and t1, respectively, and the residual magnetization and the thickness of the crystal magnetic layer 21 are denoted by Mr2 and t2, respectively, it is preferable that the product of the residual magnetization and the thickness of the crystal magnetic layer 19 be equal to the product of the residual magnetization and the thickness of the crystal magnetic layer 21, namely, Mr1×t1=Mr2×t2. Due to this, the magnetic field leakages from the crystal magnetic layer 19 and the crystal magnetic layer 21 cancel out each other; this reduces noise caused by the magnetic flux control stack structure 18 and improves the S/N ratio. In addition, when the crystal magnetic layer 19 and the crystal magnetic layer 21 are formed from the same composition, it is preferable that their thicknesses be equal, namely, t1=t2. Due to this, it is easy to fabricate the crystal magnetic layer 19 and the crystal magnetic layer 21 because it is sufficient to just control the thickness of the crystal magnetic layer 19 and the crystal magnetic layer 21.

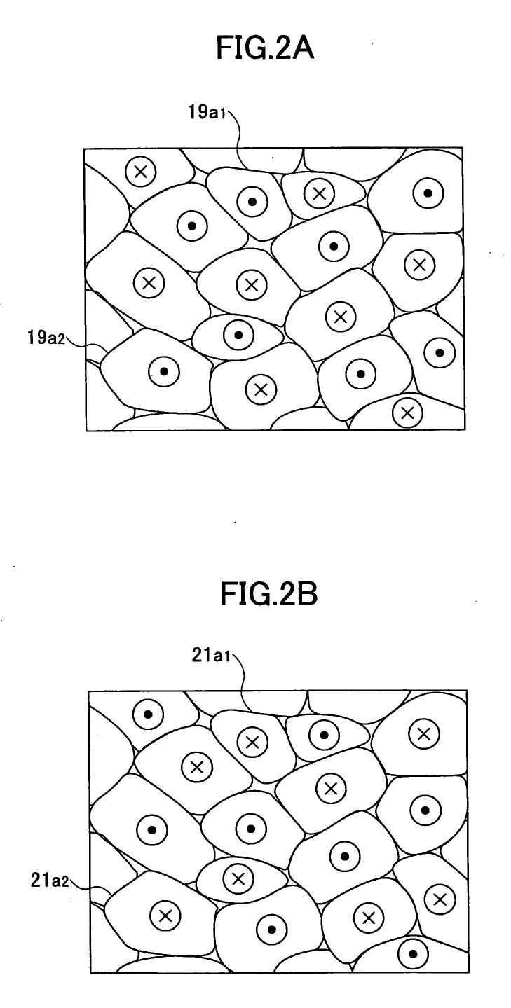

FIG. 2A and FIG. 2B are plan views illustrating crystalline states and magnetizations of the crystal magnetic layers 19 and 21 of the perpendicular magnetic recording medium 10 according to the first embodiment of the present invention.

Specifically, FIG. 2A shows the crystalline states and magnetizations of the crystal magnetic layer 19, and FIG. 2B shows the crystalline states and magnetizations of the crystal magnetic layer 21.

In FIG. 2A and FIG. 2B, dot-circle symbols indicate that the residual magnetization is upward, and dot-cross symbols indicate that the residual magnetization is downward.

Referring to FIG. 2A, FIG. 2B, and FIG. 1, the crystal magnetic layer 19 and the crystal magnetic layer 21 have nearly the same crystalline states. Namely, because the crystal magnetic layer 21 grows on the crystal magnetic layer 19 with the non-magnetic coupling layer 20 in between, the crystalline state of the crystal magnetic layer 19 is directly reflected on the crystal magnetic layer 21.

For example, a crystal grain 21a1 in FIG. 2B of the crystal magnetic layer 21 grows on a crystal grain 19a1 in FIG. 2A of the crystal magnetic layer 19 with the non-magnetic coupling layer 20 in between. Because the non-magnetic coupling layer 20 is very thin, the size and shape of the crystal grain 21a1 is nearly the same as that of the crystal grain 19a1.

In addition, the easy axis of magnetization of the crystal grain 21a1 is aligned to be parallel to the easy axis of magnetization of the crystal grain 19a1. When an external magnetic field is not applied, that is, when observing the residual magnetization, the residual magnetization of the crystal grain 21a1 is anti-parallel to the residual magnetization of the crystal grain 19a1. Due to this, the magnetic field leakages from the crystal grain 21a1 and the crystal grain 19a1 cancel out.

Here, the crystal grain 21a1 and the crystal grain 19a1 are used as an example. Certainly, the same is true for other crystal grains, for example, the crystal grain 21a2 and the crystal grain 19a2.

With the above structure, it is possible to reduce noise from the magnetic flux control stack structure 18 and improve the S/N ratio of the perpendicular magnetic recording medium 10.

In addition, since the crystal magnetic layer 19 and the crystal magnetic layer 21 are crystal, by stacking these two layers, it is possible to improve the crystallinity and the crystalline alignment of the surface of the crystal magnetic layer 21, and this improves the crystallinity and the crystalline alignment of the intermediate layer 22 and the recording layer 23 on the crystal magnetic layer 21.

In addition, since the magnetic flux control stack structure 18 is closer to the recording element of the magnetic head than the backup stack structure 12, it functions to control the flux of the recording magnetic field during recording operations. Namely, since the crystal magnetic layer 19 and the crystal magnetic layer 21 of the magnetic flux control stack structure 18 have easy axes of magnetizations perpendicular to the surface of the substrate, the recording magnetic field from the recording element is absorbed perpendicularly into the crystal magnetic layer 19 and the crystal magnetic layer 21 via the intermediate layer 22 and the recording layer 23. Thus, it is possible to prevent transverse spread of the recording magnetic field. At this moment, the magnetizations of the crystal magnetic layer 19 and the crystal magnetic layer 21 are aligned to be along the same direction as the recording magnetic filed.

In addition, since the crystal magnetic layer 19 and the crystal magnetic layer 21 are formed from a crystal material, it is possible to set the saturation magnetic flux density of the crystal magnetic layer 19 and the crystal magnetic layer 21 to be higher than that of an amorphous material; this further prevents the transverse spread of the recording magnetic field, and prevents the Wide Area Track Erasure phenomenon from occurring.

There is no limitation to the intermediate layer 22 as long as it is formed from a material able to grow on the crystal magnetic layer 21 of the magnetic flux control stack structure 18, and enables the recording layer 23 to grow on the surface of the intermediate layer 22. For example, the intermediate layer 22 may be formed from a non-magnetic material having the hcp (hexagonal closed packed) crystalline structure or the fcc (face centered cubic) crystalline structure. Specifically, the intermediate layer 22 may be formed from one non-magnetic material including one of Ru, Pd, Pt, and Ru alloys. The Ru alloys are Ru—X2 alloys having the hcp crystalline structure, where X2 represents a non-magnetic material including one of Ta, Nb, Co, Cr, Fe, Ni, Mn, O, and C.

When the recording layer 23 is formed from Co or alloys with Co as a major component, it is preferable that the intermediate layer 22 be formed from Ru or Ru—X2 alloys because good lattice matching is obtainable. The (0002) crystal plane of Co grows on the (0002) crystal plane of Ru, and a c axis (easy axis of magnetization) can be aligned perpendicular to the substrate.

The intermediate layer 22 may have a structure in which the Ru or Ru—X2 crystal grains (below, referred to as “Ru crystal grains”) are separated from each other by plural interstices. Below, this structure is referred to as “intermediate layer structure A”. Since the Ru crystal grains are nearly uniformly separated from each other, the magnetic particles of the recording layer 23 follow the arrangement of the Ru crystal grains, and this may reduce the range of the distribution of the diameters of the magnetic particles. Hence, the medium noise is reduced, and the SN ratio is raised.

In addition, as described above, since the (0002) crystal plane of Ru grows, when the recording layer 23 is formed from a ferromagnetic material with Co as a major component, the (0002) crystal plane of Co grows, and a c axis (easy axis of magnetization) is aligned perpendicular to the substrate.

Such an intermediate layer 22 can be formed by sputtering. Specifically, with a sputtering target made from Ru or Ru—X2 alloys and in an atmosphere of an inert gas, such as Ar gas, the intermediate layer 22 is sputtered with a deposition speed of 2 nm/s or lower, and the pressure of the atmosphere is 2.66 Pa or higher. However, in order that the production efficiency is not too low, it is preferable for the deposition speed to be higher than 0.1 nm/s. Further, the atmospheric gas may be an inert gas with O₂ gas being added. Due to this, the Ru-crystal grains can be well separated.

Alternatively, the intermediate layer 22 may have a structure in which the Ru-crystal grains are enclosed by immiscible layers. Below, this structure is referred to as “intermediate layer structure B”. Even with such a structure, the Ru crystal grains can be nearly uniformly separated from each other, and this may reduce the range of the distribution of the diameters of the magnetic particles. Hence, the medium noise is reduced and the SN ratio is raised.

There is no limitation to the material constituting the immiscible layers as long as the material is not soluble with Ru or Ru alloys. Preferably, the immiscible layer is formed from compounds including at least one of Si, Al, Ta, Zr, Y, Ti, and Mg, and at least one of O, C, and N, for example, SiO₂, Al₂O₃, Ta₂O₃, ZrO₂, Y₂O₃, TiO₂, MgO, or other oxides, or Si₃N₄, AlN, TaN, ZrN, TiN, Mg₃N₂, or other nitrides, or carbides like SiC, TaC, ZrC, TiC.

The intermediate layer 22 may be formed from a ferromagnetic material including one of Ni, Fe, Ni-alloys, Fe-alloys, Co, and alloys with Co as a major component. Especially, since the crystal magnetic layer 19 and the crystal magnetic layer 21 of the magnetic flux control stack structure 18 are formed from Co or alloys with Co as a major component, preferably, the intermediate layer 22 is formed from Co or alloys with Co as a major component because good lattice matching is obtainable.

The recording layer 23 may be formed from a ferromagnetic material including one of Ni, Fe, Ni-alloys, Fe-alloys, Co, and alloys with Co as a major component (below, referred to as “ferromagnetic continuous film”).

For example, the Fe-alloys may be FePt, and the alloys with Co as a major component may be one of CoPt, CoCrTa, CoCrPt, and CoCrPt-M with the atomic content of Co being 50% or more, where M represents at least one of B, Mo, Nb, Ta, W, and Cu.

Alternatively, the recording layer 23 may have a structure in which plural magnetic particles are each formed from a ferromagnetic material including one of Ni, Fe, Ni-alloys, Fe-alloys, Co, and alloys with Co as a major component, and the magnetic particles are enclosed by immiscible layers to separate the magnetic particles from each other. Below, this structure is referred to as “ferromagnetic granular structure film”. When the recording layer 23 has a ferromagnetic granular structure film, the magnetic particles can be nearly uniformly separated from each other, and this may reduce the medium noise.

Here, the alloys with Co as a major component may have the same composition as those described above. There is no limitation to the material constituting the immiscible layers as long as the material is not soluble with the magnetic particles. Preferably, the immiscible layer is formed from compounds including at least one of Si, Al, Ta, Zr, Y, Ti, and Mg, and at least one of O, C, and N, for example, SiO₂, Al₂O₃, Ta₂O₃, ZrO₂, Y₂O₃, TiO₂, MgO, or other oxides, or Si₃N₄, AlN, TaN, ZrN, TiN, Mg₃N₂, or other nitrides, or carbides like SiC, TaC, ZrC, TiC.

The recording layer 23 may include plural layers. Although not illustrated, for example, the recording layer 23 may include a first magnetic layer and a second magnetic layer stacked on the intermediate layer 22 in order. Both the first magnetic layer and the second magnetic layer may be a ferromagnetic continuous film, or a ferromagnetic granular structure film. Alternatively, one of the first magnetic layer and the second magnetic layer may be a ferromagnetic continuous film, or a ferromagnetic granular structure film.

With the recording layer 33 including two magnetic layers, each of the first magnetic layer and the second magnetic layer may be made thin, and this prevents transverse spread of magnetic particles of the first magnetic layer and the second magnetic layer when the magnetic particles grow in the film thickness direction; that is, it is possible to prevent an increase in the diameters of the magnetic particles, and this can reduce the medium noise.

In addition, in the recording layer 33, it is preferable that the first magnetic layer be a ferromagnetic continuous film, and the second magnetic layer be a ferromagnetic granular structure film. Since the saturation magnetic flux density of the ferromagnetic continuous film is higher than that of the ferromagnetic granular structure film, if the ferromagnetic continuous film is arranged to be near the reproduction element of the magnetic head, it is possible to increase the reproduction output. Further, since the magnetic particles in the ferromagnetic granular structure film of the first magnetic layer follow the arrangement of the crystal grains of the intermediate layer 22, and the magnetic particles are arranged uniformly in the film, it is possible to reduce the medium noise in the ferromagnetic granular structure film of the second magnetic layer.

Further, since the magnetic particles in the ferromagnetic continuous film of the first magnetic layer follow the arrangement of the magnetic particles in the ferromagnetic granular structure film of the second magnetic layer 33a, the magnetic particles are arranged uniformly in the film, and it is possible to further reduce the medium noise in the ferromagnetic continuous film of the first magnetic layer.

It should be noted that the number of the magnetic layers in the recording layer 33 is not limited to two, but may be three or more.

It is preferable that the magnetic flux control stack structure 18, the intermediate layer 22, and the recording layer 23 be combined so as to have the following structure. Specifically, the crystal magnetic layer 19 and the crystal magnetic layer 21 of the magnetic flux control layer 18 is formed from Co or a Co—X1 alloy having a hcp crystalline structure, the intermediate layer 22 has the above-mentioned intermediate layer structure A or intermediate layer structure B, and the recording layer 23 has the ferromagnetic granular structure film. In this case, it is preferable that the magnetic particles of the ferromagnetic granular structure film be formed from the alloys with Co as a major component, as described above.

With such a combination, the Ru crystal grains of the intermediate layer 22 grow on the crystal grains 21a of the crystal magnetic layer 21 of the magnetic flux control layer 18; further, the magnetic particles of the recording layer 23 grow on the Ru crystal grains of the intermediate layer 22. Due to this, the range of the distribution of the diameters of the magnetic particles of the recording layer 23 can be reduced, the medium noise can be reduced, and the SN ratio can be improved.

The Co (0002) crystalline plane of the crystal magnetic layer 19 and the crystal magnetic layer 21 of the magnetic flux control layer 18 becomes a growing plane, and the (0002) crystal plane of Ru grows thereon with good lattice matching. Thus, it is possible to improve the crystallinity and the crystalline alignment of the Ru crystal grains. Further, the (0002) crystal plane of Co magnetic particles grows on the (0002) crystal plane of Ru crystal grains with good lattice matching. Hence, it is possible to improve the crystallinity and the crystalline alignment of the magnetic particles. As a result, it is possible to improve the magnetic property of the recording layer 23 of the perpendicular magnetic recording medium 10 and the recording and reproduction property of the perpendicular magnetic recording medium 10.

There is no limitation to the protection film 24. For example, the protection film 24 may be 0.5 nm to 15 nm in thickness, and may be formed from amorphous carbon, carbon hydride, carbon nitride, aluminum oxide, and the like.

There is no limitation to the lubrication layer 25. For example, the lubrication layer 25 may be 0.5 nm to 5 nm in thickness, and may be formed by a lubricant having a main chain of perfluoropolyether. Depending on the materials of the protection film 24, the lubrication layer 18 may be provided or be omitted.

The above layers of the perpendicular magnetic recording medium 10 can be fabricated by sputtering except those described above. During sputtering, sputtering targets made from the materials of the layers are used, and sputtering is performed in an atmosphere of an inert gas, such as Ar gas to deposit the films. When fabricating the films, in order that the amorphous soft magnetic layer 13 and the amorphous soft magnetic layer 15 of the backup stack structure 12 are not crystallized, it is preferable that the substrate 11 not be heated. Certainly, the substrate 11 can be heated to a temperature at which the amorphous soft magnetic layers 13 and 15 of the backup stack structure 12 are not crystallized, or the substrate 11 can be heated to remove moisture on the surface of the substrate 11 before the amorphous soft magnetic layers 13 and 15 are formed, and then the amorphous soft magnetic layers 13 and 15 are formed after the substrate 11 is cooled.

As described above, in the perpendicular magnetic recording medium 10, the magnetic flux control stack structure 18 includes the crystal magnetic layer 19 and the crystal magnetic layer 21, and the non-magnetic coupling layer 20 in between. Because the crystal magnetic layer 19 and the crystal magnetic layer 21 are crystals, it is possible to improve the crystallinity and the crystalline alignment of the intermediate layer 22 and the recording layer 23 on the magnetic flux control stack structure 18, and improve the magnetic property and recording-reproduction performance of the recording layer 23.

Further, since the crystal magnetic layer 19 and the crystal magnetic layer 21 of the magnetic flux control stack structure 18 are coupled by anti-ferromagnetic exchange coupling, the magnetic field leakages from the crystal magnetic layer 19 and the crystal magnetic layer 21 cancel out each other. Due to this, it is possible to reduce the magnetic field leakage from the magnetic flux control stack structure 18; this reduces noise caused by the magnetic flux control stack structure 18, and prevents noise from being detected by the reproduction element of the magnetic head. As a result, it is possible to perform high density recording in the perpendicular magnetic recording medium 10.

Further, since the crystal magnetic layer 19 and the crystal magnetic layer 21 of the magnetic flux control layer 18 have easy axes of magnetization perpendicular to the surface of the substrate 11, the recording magnetic field from the recording element is absorbed perpendicularly by the magnetic flux control layer 18, thus, it is possible to prevent transverse spread of the recording magnetic field, and prevents the Wide Area Track Erasure phenomenon from occurring.

Below, other examples of the perpendicular magnetic recording medium of the present embodiment are described.

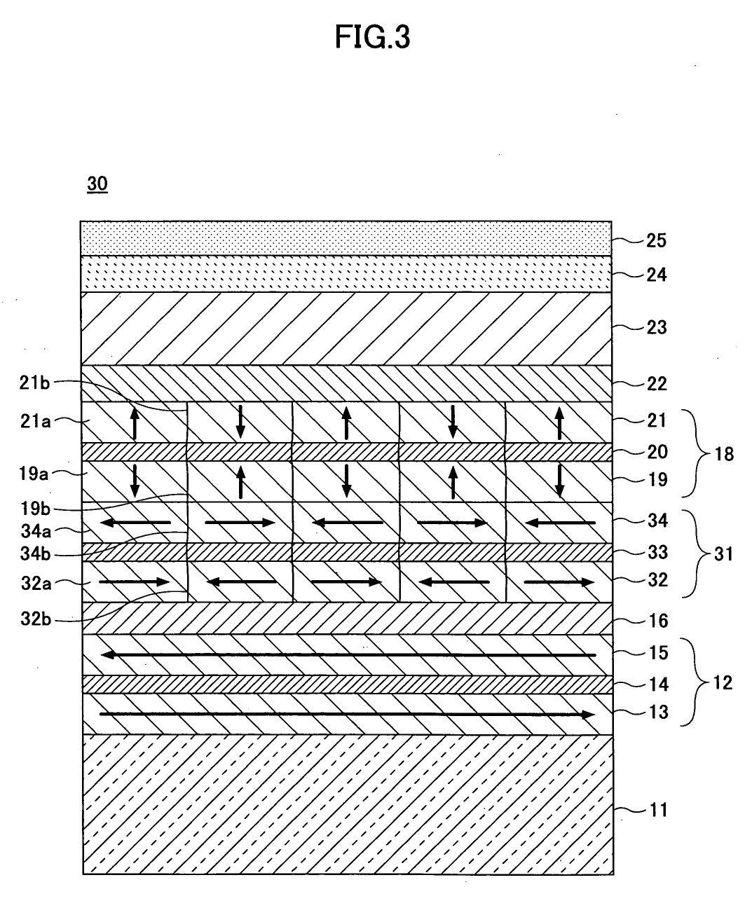

FIG. 3 is a schematic cross-sectional view illustrating another example of a perpendicular magnetic recording medium according to the first embodiment of the present invention.

The perpendicular magnetic recording medium shown in FIG. 3 is a modification of the perpendicular magnetic recording medium 10 shown in FIG. 1.

In FIG. 3, the same reference numbers are used for the same elements as those in the previous example, and overlapping descriptions are omitted.

FIG. 3 shows a perpendicular magnetic recording medium 30, which includes a substrate 11, and a first backup stack structure 12, a separation layer 16, a second backup stack structure 31, a magnetic flux control stack structure 18, an intermediate layer 22, a recording layer 23, a protection film 24, and a lubrication layer 25 stacked on the substrate 11 in order.

The perpendicular magnetic recording medium 30 is basically the same as the perpendicular magnetic recording medium 10 except that the second backup stack structure 31 is disposed between the separation layer 16 and the magnetic flux control stack structure 18. Further, the first backup stack structure 12 has the same structure as the backup stack structure 12 in FIG. 1, and thus the same reference number 12 is used.

The second backup stack structure 31 includes a crystal soft magnetic layer 32 and a crystal soft magnetic layer 34, and a non-magnetic coupling layer 33 in between. For example, each of the crystal soft magnetic layer 32 and the crystal soft magnetic layer 34 is formed from a crystal soft magnetic material, and includes plural crystal grains 32a and 34a, and the crystal grains 32a and 34a are in close contact with each other via granular boundaries 33b and 34b. The easy axes of magnetizations of crystal grains 32a and 34a are parallel to the substrate (in-plane state), and is randomly orientated in-plane.

Since the crystal soft magnetic layer 32 and the crystal soft magnetic layer 34 of the second backup stack structure 31 are formed from crystal materials, the crystallinity and the crystalline alignment of the crystal magnetic layer 19 on the crystal soft magnetic layer 34 are improved.

In addition, when the crystal soft magnetic layer 32 and the crystal soft magnetic layer 34 are thicker, the crystallinity and the crystalline alignment of the crystal soft magnetic layer 32 and the crystal soft magnetic layer 34 are better, and this prevents magnetic saturation caused by the recording magnetic field. From the point of view of enhancing the perpendicular coercive force and the nucleus formation magnetic field of the recording layer 23, and improving the S/N ratio, it is preferable for the total thickness of the crystal soft magnetic layer 32 and the crystal soft magnetic layer 34 to be less than 10 nm. It is more preferable for the thickness of each of the crystal soft magnetic layer 32 and the crystal soft magnetic layer 34 to be in the range from 1 nm to 5 nm. When the total thickness of the crystal soft magnetic layer 32 and the crystal soft magnetic layer 34 is greater than 10 nm, the perpendicular coercive force of the recording layer 23 increases too much, and the overwrite property of the recording layer 23 is apt to decline. However, even in this case, if the thickness of the intermediate layer 22 is reduced appropriately, increase of the perpendicular coercive force of the recording layer 23 and declination of the overwrite property of the recording layer 23 are preventable.

Preferably, each of the crystal soft magnetic layer 32 and the crystal soft magnetic layer 34 may be formed from one of Ni, NiFe, and NiFe alloys. When the crystal soft magnetic layer 32 and the crystal soft magnetic layer 34 are formed from Ni, or NiFe, or NiFe alloys, a (111) crystal plane becomes a growing plane. Due to this, when the crystal magnetic layer 19, which is disposed on the crystal soft magnetic layer 32 and the crystal soft magnetic layer 34, is formed from Co or Co—X1 alloys having a hcp crystalline structure, good lattice matching between the crystal soft magnetic layer 34 and the crystal magnetic layer 19 can be obtained. As a result, the crystallinity and the crystalline alignment of the crystal magnetic layer 19 and the crystal magnetic layer 21 are improved, hence, the recording magnetic field is more focused, and this prevents the Wide Area Track Erasure phenomenon from occurring. Further, the crystallinity and the crystalline alignment of the recording layer 23 are improved, and this improves the magnetic property (such as perpendicular coercive force) and recording-reproduction performance of the recording layer 23.

The NiFe alloys can be denoted as NiFe—X3, where the additive element X3 may be one or more of Cr, Ru, Si, O, N, and SiO₂. By adding the additive element X3 to NiFe, the saturation magnetic flux density can be reduced while maintaining the crystalline structure of NiFe. Thus even when the thicknesses of the crystal soft magnetic layer 32 and the crystal soft magnetic layer 34 deviate from a preset value, it is possible to prevent magnetic field leakage from the crystal soft magnetic layer 32 and the crystal soft magnetic layer 34, and reduce adverse influence of the deviated film thicknesses.

A NiFe—O film and a NiFe—N film can be formed by adding O₂ gas and N₂ gas to inert gas (such as Ar gas), which serves as the atmospheric gas when forming the crystal soft magnetic layer 32 and the crystal soft magnetic layer 34, and sputtering the NiFe—O film or the NiFe—N film by using a NiFe sputtering target. In this way, the NiFe—O film or the NiFe—N film becomes a poly crystal film having a good diameter distribution of the crystal grains. In this process, preferably, the O₂ gas or the N₂ gas is added at a volume concentration of 2% or less.

The non-magnetic coupling layer 33 may be formed from non-magnetic transition metals. Preferably, the non-magnetic coupling layer 33 may be formed from the same material, and have a thickness in the same range as the non-magnetic coupling layer 20 in the example shown in FIG. 1.

If the residual magnetization and the thickness of the crystal soft magnetic layer 32 are denoted by Mr3 and t3, respectively, and the residual magnetization and the thickness of the crystal soft magnetic layer 34 are denoted by Mr4 and t4, respectively, it is preferable that the product of the residual magnetization and the thickness of the crystal soft magnetic layer 32 be equal to the product of the residual magnetization and the thickness of the crystal soft magnetic layer 34, namely, Mr3×t3=Mr4×t4. Due to this, the magnetic field leakages from the crystal soft magnetic layer 32 and the crystal soft magnetic layer 34 cancel out each other; this reduces noise caused by the second backup stack structure 31 and improves the S/N ratio. In addition, when the crystal soft magnetic layer 32 and the crystal soft magnetic layer 34 have the same composition, it is preferable that their thicknesses be equal, namely, t3=t4. Due to this, it is easy to fabricate the crystal soft magnetic layer 32 and the crystal soft magnetic layer 34 because it is sufficient to just control the thickness of the crystal soft magnetic layer 32 and the crystal soft magnetic layer 34.

The second backup stack structure 31 has the following functions during recording operation. The recording magnetic field from the recording element is absorbed by the magnetic flux control layer 18 via the recording layer 23, and is supplied to the second backup stack structure 31. When the recording magnetic field is in an opposite direction, the path is reversed. Since the crystal soft magnetic layer 34 of the second backup stack structure 31 is in contact with the crystal magnetic layer 19 of the magnetic flux control layer 18, the magnetic resistance at their interface is low, thus, it is possible to prevent transverse spread of the recording magnetic field, and this prevents spread of the recording magnetic field in the recording layer 23. Therefore, it is possible to prevent the Wide Area Track Erasure phenomenon from occurring.

By providing the second backup stack structure 31, it is possible to reduce the thicknesses of the amorphous soft magnetic layer 13 and the amorphous soft magnetic layer 15 of the first backup stack structure 12. Hence, it is possible to further prevent noise spike from occurring in the first backup stack structure 12.

Since the magnetic flux control layer 18 is formed on the second backup stack structure 31, the crystallinity and the crystalline alignment of the crystal soft magnetic layer 34 follow those of the crystal magnetic layer 19. For this reason, the crystallinity and the crystalline alignment of the magnetic flux control layer 18 are better than those in the perpendicular magnetic recording medium 10 shown in FIG. 1.

Especially, when the crystal soft magnetic layer 32 and the crystal soft magnetic layer 34 are formed from one of Ni, NiFe, and NiFe alloys, it is preferable that the crystal magnetic layer 19 and the crystal magnetic layer 21 be formed from Co or Co—X1 alloys having a hcp crystalline structure. Due to this, the Ni (111) crystal plane of the crystal soft magnetic layer 34 grows on the Co (0002) crystal plane of the crystal magnetic layer 19 with good lattice matching. As a result, the crystallinity and the crystalline alignment of the intermediate layer 22, furthermore, of the recording layer 23 are improved, and this further improves the magnetic property and recording-reproduction performance of the recording layer 23.

In the perpendicular magnetic recording medium 30, by disposing the second backup stack structure 31 between the separation layer 16 and the magnetic flux control stack structure 18, it is possible to further improve the crystallinity and the crystalline alignment of the intermediate layer 22, furthermore, of the recording layer 23, and this further improves the magnetic property and recording-reproduction performance of the recording layer 23.

In addition, since the crystal soft magnetic layer 34 of the second backup stack structure 31 is in contact with the crystal magnetic layer 19 of the magnetic flux control layer 18, the Wide Area Track Erasure phenomenon is preventable.

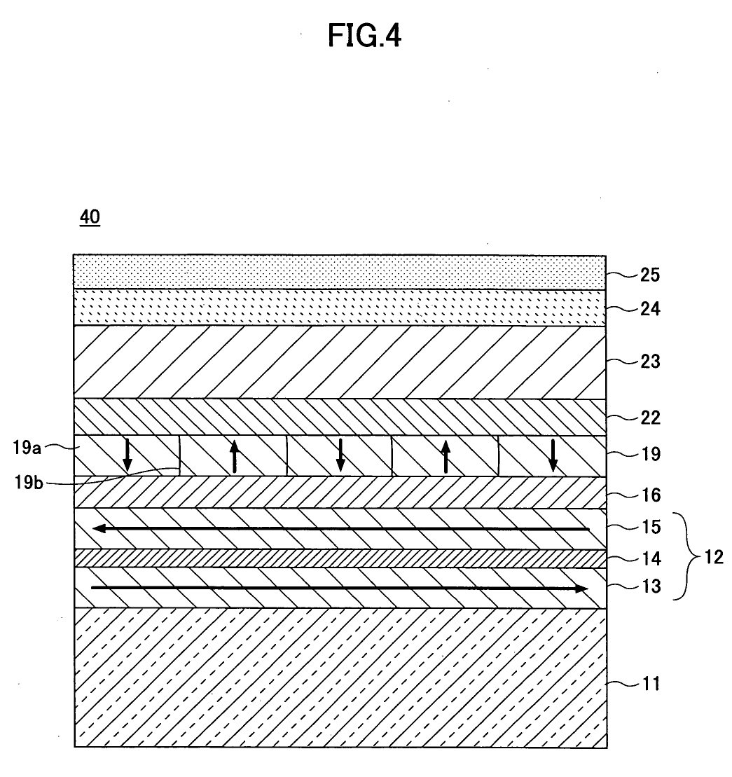

FIG. 4 is a schematic cross-sectional view illustrating another example of a perpendicular magnetic recording medium according to the first embodiment of the present invention.

The perpendicular magnetic recording medium in the present example is a modification of the perpendicular magnetic recording medium 10 in FIG. 1.

In FIG. 4, the same reference numbers are used for the same elements as those in the previous examples, and overlapping descriptions are omitted.

FIG. 4 shows a perpendicular magnetic recording medium 40, which includes a substrate 11, and a first backup stack structure 12, a separation layer 16, a magnetic flux control layer 19, an intermediate layer 22, a recording layer 23, a protection film 24, and a lubrication layer 25 stacked on the substrate 11 in order.

The perpendicular magnetic recording medium 40 is basically the same as the perpendicular magnetic recording medium 10 except that the non-magnetic coupling layer 20 and the crystal magnetic layer 21 of the magnetic flux control stack structure 18 are omitted. Further, the magnetic flux control layer 19 in the present example is formed from the same material and has the same film thickness as the crystal magnetic layer 19 in FIG. 1, and thus the same reference number 19 is used.

In the perpendicular magnetic recording medium 40, since the easy axis of magnetization of the magnetic flux control layer 19 is perpendicular to the substrate, the recording magnetic field from the recording element is absorbed perpendicularly into the magnetic flux control layer 19 via the intermediate layer 22 and the recording layer 23. Thus, it is possible to prevent transverse spread of the recording magnetic field.

Especially, since the magnetic flux control layer 19 is formed from a crystal material, it is possible to set the saturation magnetic flux density of the magnetic flux control layer 19 to be higher than that of an amorphous material, and this further prevents the transverse spread of the recording magnetic field, and prevents the Wide Area Track Erasure phenomenon from occurring.

In addition, since the magnetic flux control layer 19 is formed from a crystal material, it is possible to improve the crystallinity and the crystalline alignment of the intermediate layer 22 and the recording layer 23 on the crystal magnetic layer 21.

It is preferable that the thickness of the magnetic flux control layer 19 be 2 nm-10 nm in order to obtain the above advantages and to reduce noise from the reproduction element.

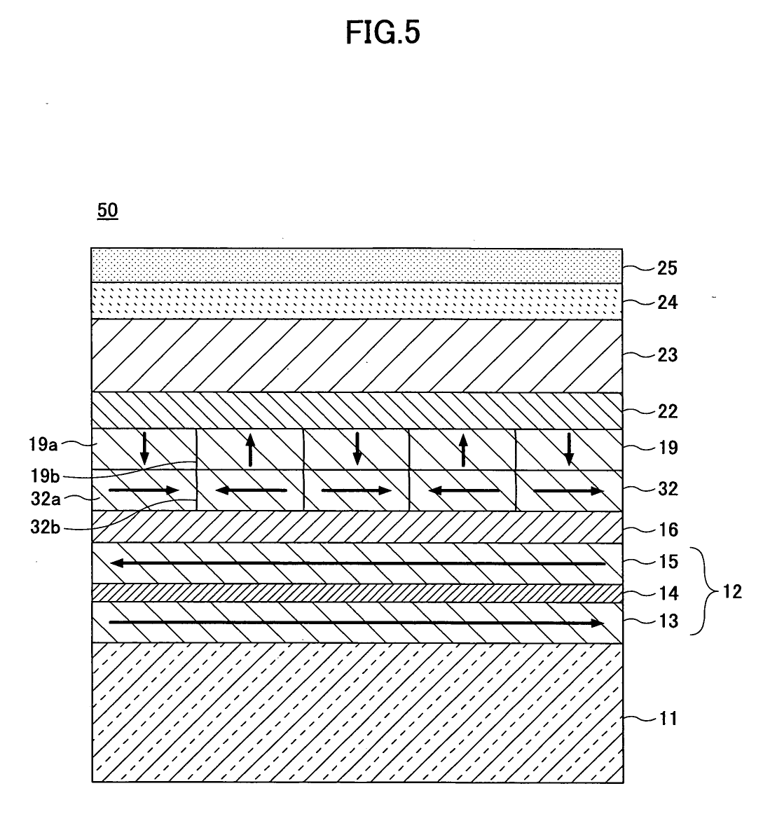

FIG. 5 is a schematic cross-sectional view illustrating another example of a perpendicular magnetic recording medium according to the first embodiment of the present invention.

The perpendicular magnetic recording medium in the present example is a modification of the perpendicular magnetic recording medium 30 in FIG. 3.

In FIG. 5, the same reference numbers are used for the same elements as those in the previous examples, and overlapping descriptions are omitted.

FIG. 5 shows a perpendicular magnetic recording medium 50, which includes a substrate 11, and a first backup stack structure 12, a separation layer 16, a crystal soft magnetic layer 32, a magnetic flux control layer 19, an intermediate layer 22, a recording layer 23, a protection film 24, and a lubrication layer 25 stacked on the substrate 11 in order.

The perpendicular magnetic recording medium 50 is basically the same as the perpendicular magnetic recording medium 30 in FIG. 3 except that the second backup stack structure 31 is replaced by the crystal soft magnetic layer 32, and the magnetic flux control stack structure 18 is replaced by the magnetic flux control layer 19.

The magnetic flux control layer 19 and the crystal soft magnetic layer 32 in the present example are respectively formed from the same material and have the same film thicknesses as the magnetic flux control layer 19 and the crystal soft magnetic layer 32 in FIG. 1, and thus the same reference numbers 19, 32 are used.

In the perpendicular magnetic recording medium 50, since the easy axis of magnetization of the magnetic flux control layer 19 is perpendicular to the substrate 11, the recording magnetic field from the recording element is absorbed perpendicularly into the magnetic flux control layer 19 via the intermediate layer 22 and the recording layer 23. Thus, it is possible to prevent transverse spread of the recording magnetic field.

In addition, since the crystal soft magnetic layer 32 is formed to be adjacent to the magnetic flux control layer 19, the recording magnetic field further distributes into the crystal soft magnetic layer 32, and this further prevents spread of the distribution of the recording magnetic field.

Since the spread of the recording magnetic field is further preventable, it is possible to prevent the Wide Area Track Erasure phenomenon from occurring.

Additionally, since the crystal soft magnetic layer 32 and the magnetic flux control layer 19 are formed from a crystal material, it is possible to improve the crystallinity and the crystalline alignment of the intermediate layer 22 and the recording layer 23 on the crystal magnetic layer 21.

It is preferable that the thickness of the crystal soft magnetic layer 32 and the magnetic flux control layer 19 be 2 nm-10 nm in order to obtain the above advantages and to reduce noise from the reproduction element.

Below, examples of the perpendicular magnetic recording media of the present embodiment are provided.

### EXAMPLE 1

As example 1 of the present embodiment, a perpendicular magnetic recording medium was fabricated as described below. The perpendicular magnetic recording medium of this example has the same structure as that of the perpendicular magnetic recording medium 10 in FIG. 1. Thus, in the following, the same reference numbers are used as in FIG. 1. The figures in parentheses indicate film thicknesses.

Specifically, the perpendicular magnetic recording medium of this example includes the following components.

A substrate 11: a glass substrate,

A first backup stack structure 12:
amorphous soft magnetic layers 13, 15: CoNbZr films (each film 25 nm),
a non-magnetic coupling layer 14: Ru film (0.6 nm),

A separation layer 16: Ta film (3 nm)

A magnetic flux control stack structure 18:
crystal magnetic layers 19, 21: CoCrPtB film,
a non-magnetic coupling layer 20: Ru film (0.6 nm),

An intermediate layer 22: Ru film (20 nm)

A recording layer 23:
a stack structure including a CoCrPt—SiO₂ film (10 nm) and a CoCrPtB film (6 nm) on the intermediate layer 22,

A protection film 24: carbon film (4.5 nm)

A lubrication layer 25: perfluoropolyether (1.5 nm).

Magnetic disks having different thicknesses of the CoCrPtB films, which serve as the crystal magnetic layers 19, 21 of the magnetic flux control stack structure 18, were fabricated. Specifically, the thickness of the CoCrPtB film was in the range from 1 nm to 4 nm with the thickness intervals being 1 nm. For the purpose of comparison, a magnetic disk having nearly the same structure as that of the perpendicular magnetic recording medium 10 in FIG. 1 but without the magnetic flux control stack structure 18 was also fabricated (example for comparison).

### EXAMPLE 2

As example 2 of the present embodiment, a perpendicular magnetic recording medium was fabricated as described below. The perpendicular magnetic recording medium of the example 2 has the same structure as that of the perpendicular magnetic recording medium 50 in FIG. 4.

Specifically, the perpendicular magnetic recording medium of the example 2 has nearly the same structure as that of the perpendicular magnetic recording medium 10 in FIG. 1 except that the crystal magnetic layer 19 (magnetic flux control layer 19) is provided, and the non-magnetic coupling layer 20 and the crystal magnetic layer 21 are omitted.

Magnetic disks having different thicknesses of the CoCrPtB films, which serve as the magnetic flux control layer 19, were fabricated. Specifically, the thickness of the CoCrPtB film was in the range from 2 nm to 8 nm with the thickness intervals being 2 nm.

The perpendicular magnetic recording medium of the example 1, the example for comparison, and example 2 were fabricated in the following way. A cleaned glass substrate 11 was conveyed to a sputtering chamber, and the above films (except for the lubricant film 25) were formed by using a DC magnetron without heating the substrate 11. An Ar gas was introduced into the chamber and was set at a pressure of 0.7 Pa. Next, the lubricant film 25 was deposited on the protection film 24 by immersion.

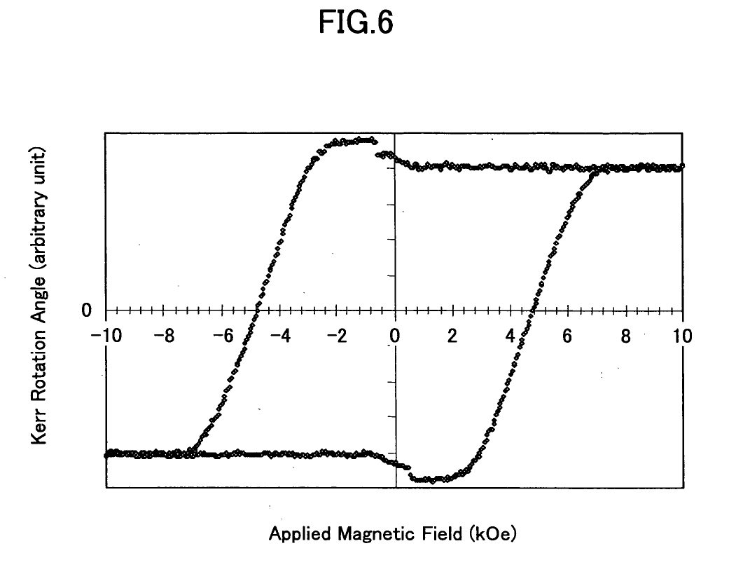

FIG. 6 shows a hysterisis loop of the perpendicular magnetic recording medium of the example 1.

The hysterisis loop in FIG. 6 was measured with the thickness of the CoCrPtB film being 4 nm, which serves as the crystal magnetic layer 19 and the crystal magnetic layer 21 in example 1, by using a Kerr-effect measurement device.

As shown in the hysterisis loop in FIG. 6, a magnetic field of 10 kOe in magnitude is perpendicularly applied to the substrate at the beginning. When the magnetic field is lowered to zero Oe, and then is further increased in the opposite direction, the Kerr rotation angle increases, and exhibits a maximum in the range from −1 kOe to −3 kOe. This maximum is even greater than the value of the Kerr rotation angle when the applied magnetic field is zero (namely, in a residual magnetization state). The hysterisis loop in FIG. 6 is a typical one for the magnetic flux control stack structure 18 in the perpendicular magnetic recording medium 10 as shown in FIG. 1, but the reason of this feature of the hysterisis loop is not clarified, yet.

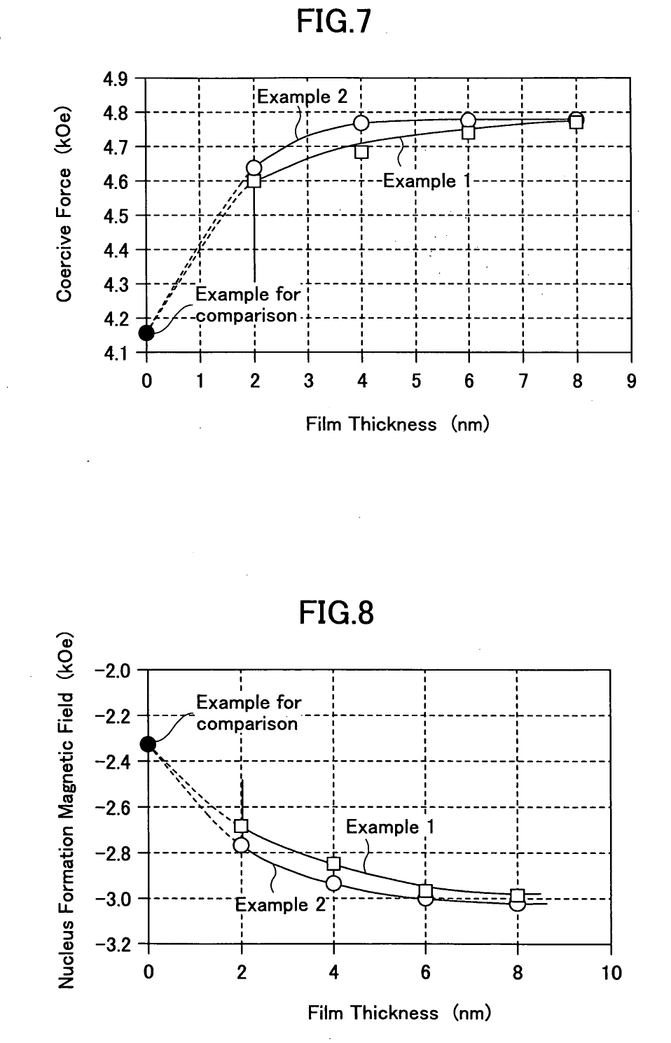

FIG. 7 shows experimental results of the relation between the perpendicular coercive force and the film thickness of the crystal magnetic layer.

In FIG. 7, the open squares and the open circles indicate the experimental results of the perpendicular coercive force in the example 1 and example 2, respectively, and the closed circle indicates the experimental result of the example for comparison.

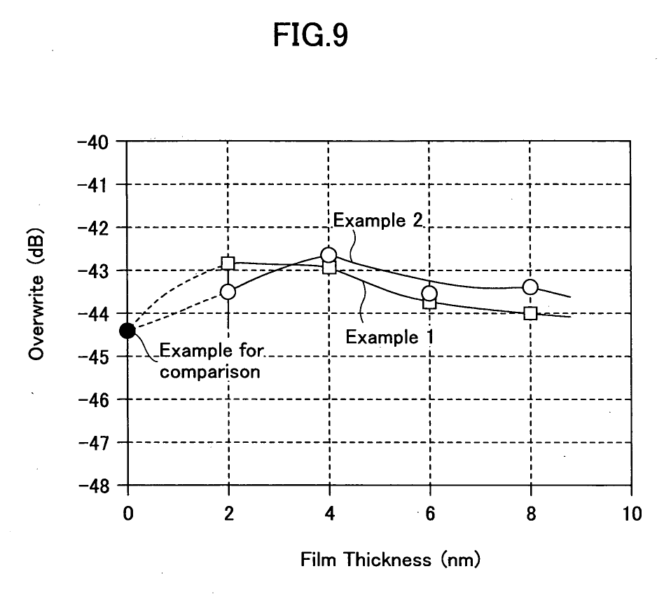

It should be noted that for the example 1, the abscissa in FIG. 7, and the subsequent FIG. 8 and FIG. 9, indicate the total thickness of the two crystal magnetic layers.

FIG. 7 reveals that when the film thickness of the crystal magnetic layer is greater than 2 nm, the perpendicular coercive force rises up to or even greater than 5000 Oe.

FIG. 8 shows experimental results of the relation between the nucleus formation magnetic field and the film thickness of the crystal magnetic layer.

Similar to FIG. 7, in FIG. 8, the open squares and the open circles indicate the experimental results of the example 1 and example 2, respectively, and the closed circle indicates the experimental result of the example for comparison.

FIG. 8 reveals that when the film thickness of the crystal magnetic layer increases, the absolute value of the nucleus formation magnetic field increases and becomes greater than that in the example for comparison, indicating that the squareness of the hysteresis loop is good.

These experimental results show that the magnetic properties of the recording layer 23 are improved by using the crystal magnetic layer.

FIG. 9 shows experimental results of the relation between the overwrite property and the film thickness of the crystal magnetic layer.

Similarly, in FIG. 9, the open squares and the open circles indicate the experimental results in the example 1 and example 2, respectively, and the closed circle indicates the experimental result of the example for comparison.

As shown in FIG. 9, the overwrite property is degraded by 1 dB or 2 dB. However, comparing to the increase of the perpendicular coercive force in example 1 and example 2 with respect the example for comparison, the degradation of the overwrite property is small. It is though that this is ascribed to improved crystalline alignment of the recording layer.

### EXAMPLE 3

As example 3 of the present embodiment, a perpendicular magnetic recording medium was fabricated as described below. The perpendicular magnetic recording medium of this example has the same structure as the perpendicular magnetic recording medium 50 in FIG. 5. Thus, in the following, the same reference numbers are used as in FIG. 5. The figures in parentheses indicate film thicknesses.

Specifically, the perpendicular magnetic recording medium of this example includes the following components.

A substrate 11: a glass substrate,

A first backup stack structure 12:
amorphous soft magnetic layers 13, 15: CoNbZr films (each film 25 nm),
a non-magnetic coupling layer 14: Ru film (0.6 nm),

A separation layer 16: Ta film (3 nm)

A crystal soft magnetic layer 32: Ni₈₀Fe₂₀ film (5 nm),

A magnetic flux control layer 19: CoCrPtB film (3 nm),

An intermediate layer 22: Ru film (20 nm)

A recording layer 23:
a stack structure including a CoCrPt—SiO₂ film (10 nm) and a CoCrPtB film (6 nm) on the intermediate layer 22,

A protection film 24: carbon film (4.5 nm)

A lubrication layer 25: perfluoropolyether (1.5 nm).

### EXAMPLE 4

As example 4 of the present embodiment, a perpendicular magnetic recording medium was fabricated as described below. The perpendicular magnetic recording medium of this example has the same structure as the perpendicular magnetic recording medium 10 in FIG. 1. Thus, in the following, the same reference numbers are used as in FIG. 1. The figures in parentheses indicate film thicknesses.

Specifically, the perpendicular magnetic recording medium of this example includes the following components.

A substrate 11: a glass substrate,

A first backup stack structure 12:
amorphous soft magnetic layers 13, 15: CoNbZr films (each film 25 nm),
a non-magnetic coupling layer 14: Ru film (0.6 nm),

A separation layer 16: Ta film (3 nm)

A magnetic flux control stack structure 18:
crystal magnetic layers 19, 21: CoCr films (1 nm),
a non-magnetic coupling layer 20: Ru film (0.6 nm),

An intermediate layer 22: Ru film (20 nm)

A recording layer 23:
a stack structure including a CoCrPt—SiO₂ film (10 nm) and a CoCrPtB film (6 nm) on the intermediate layer 22,

A protection film 24: carbon film (4.5 nm)

A lubrication layer 25: perfluoropolyether (1.5 nm).

Note that the perpendicular magnetic recording media in example 3 and example 4 were fabricated under the same conditions as in the example 1.

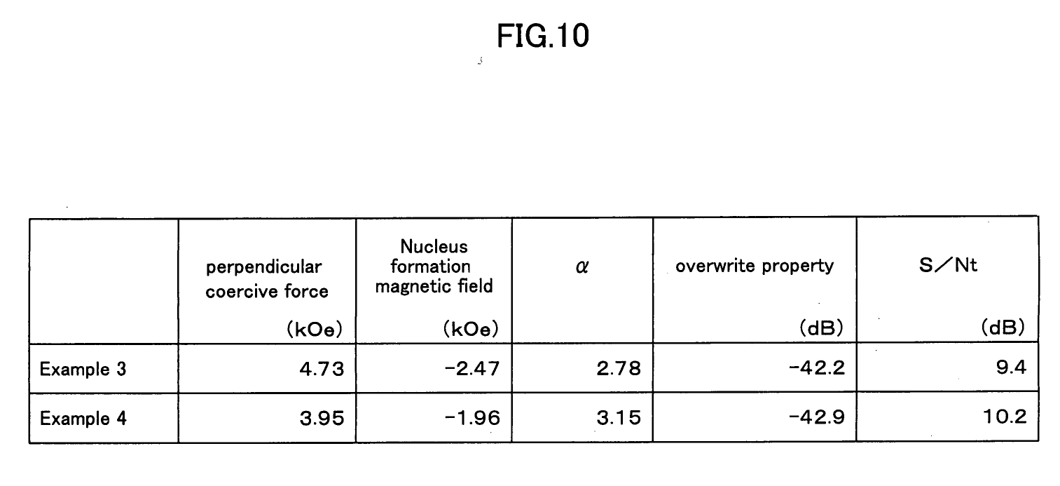

FIG. 10 is a table showing properties of the perpendicular magnetic recording media of the example 3 and the example 4.

FIG. 10 shows magnetic properties including the perpendicular coercive force, the nucleus formation magnetic field, and a parameter α. The perpendicular coercive force, the nucleus formation magnetic field, and α, were calculated from the hysteresis loop of the Kerr rotation angle, which was obtained by applying a magnetic field in a direction perpendicular to the substrate. The nucleus formation magnetic field corresponds to the applied magnetic field which results in the tangential line of the hysteresis loop, which hysteresis loop is obtained when applying a magnetic field so that the Kerr rotation angle is zero, to be at the Kerr rotation angle when the applied magnetic field is zero. The parameter α indicates the inclination of the hysteresis loop when a magnetic field is applied so that the Kerr rotation angle is zero.

As described above, in the example 3, a Ni₈₀Fe₂₀ film (5 nm) and a CoCrPtB film (3 nm) are provided to serve as the crystal soft magnetic layer 32 and the magnetic flux control layer 19, respectively, Whereas in the example 4, a stack structure of CoCr film (1 nm)/Ru film (0.6 nm)/CoCr film (1 nm) is provided to serve as the magnetic flux control stack structure 18.

As shown in FIG. 10, the magnetic properties of the example 3 is roughly the same as or better than those of the example 4, whereas the S/Nt ratio in the example 4 is better than that in the example 3. This reveals that compared to the magnetic field leakage from the Ni₈₀Fe₂₀ film in example 3, the magnetic field leakage from the magnetic flux control stack structure 18 is much reduced in the example 4 with a structure involving anti-ferromagnetic exchange coupling.

In addition, overwrite property and S/Nt were measured by using a commercially available spin stand and a composite magnetic head having an induction recording element, and a GMR (Giant Magneto-Resistive) element. Here, S represents an average output at 150 kBPI, and Nt represents the noise including both the medium noise and the device noise.

### Second Embodiment

This embodiment relates to a magnetic storage device using the perpendicular magnetic recording media of the previous embodiment.

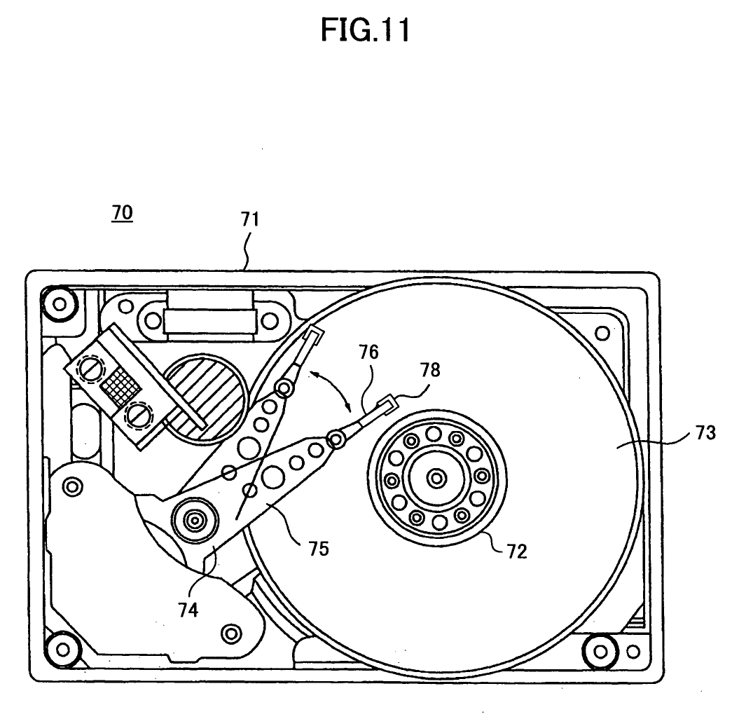

FIG. 11 is a schematic view of a principal portion of a magnetic storage device according to a second embodiment of the present invention.

As illustrated in FIG. 7, a magnetic storage device 70 includes a housing 71, and in the housing 71 there are arranged a hub 72 driven by a not-illustrated spindle, a perpendicular magnetic recording medium 73 rotably fixed to the hub 72, an actuator unit 74, an arm 75 attached to the actuator unit 74 and movable in a radial direction of the perpendicular magnetic recording medium 73, a suspension 76, and a magnetic head 78 supported by the suspension 76.

For example, the magnetic head 78 has a reproduction head, which has a single-pole recording head and a GMR (Giant Magneto-Resistive) element.

Although not illustrated, the single-pole recording head includes a main magnetic pole formed from a soft magnetic material for applying a recording magnetic field on the perpendicular magnetic recording medium 73, a return yoke magnetically connected to the main magnetic pole, and a recording coil for guiding the recording magnetic field to the main magnetic pole and the return yoke. The single-pole recording head applies a recording magnetic field on the perpendicular magnetic recording medium 73 from the main magnetic pole in the perpendicular direction, and magnetizes the perpendicular magnetic recording medium 73 in the perpendicular direction.

Although not illustrated, the reproduction head has a GMR element. The GMR element is able to detect magnetic field leakage of magnetizations of the perpendicular magnetic recording medium 73, and obtains the data recorded in the perpendicular magnetic recording medium 73 according to variation of a resistance of the GMR element corresponding to the direction of the detected magnetic field. It should be noted that instead of the GMR element, a TMR (Ferromagnetic Tunnel Junction Magneto-Resistive) element can be used.

In the magnetic storage device 70, the perpendicular magnetic recording media of the previous embodiment are used as the perpendicular magnetic recording medium 73. Hence, the perpendicular magnetic recording medium 73 is of a good SN ratio and is able to prevent the Wide Area Track Erasure phenomenon.

It should be noted the configuration of the magnetic storage device 70 is not limited to that shown in FIG. 11, and the magnetic head 78 is not limited to the above configuration, either. Any well-known magnetic head can be used. Further, the perpendicular magnetic recording medium 73 is not limited to magnetic disks; it may also be magnetic tapes.

According to the present embodiment, it is possible to realize high density recording and the long-term reliability of the perpendicular magnetic recording medium, and prevent the Wide Area Track Erasure phenomenon.

While the invention is described above with reference to specific embodiments chosen for purpose of illustration, it should be apparent that the invention is not limited to these embodiments, but numerous modifications could be made thereto by those skilled in the art without departing from the basic concept and scope of the invention.

What is claimed is:

1. A perpendicular magnetic recording medium, comprising:
a substrate;
a soft-magnetic backup layer on the substrate;
a separation layer on the soft-magnetic backup layer and formed from a non-magnetic material;
a magnetic flux control layer on the separation layer; and
a recording layer on the magnetic flux control layer, said recording layer having an easy axis of magnetization perpendicular to the surface of the substrate;
wherein
the magnetic flux control layer is formed from a poly-crystal ferromagnetic material having an easy axis of magnetization perpendicular to the surface of the substrate.

2. The perpendicular magnetic recording medium as claimed in claim 1, wherein the magnetic flux control layer is formed from Co or a Co—X1 alloy having a hcp crystalline structure, where X1 represents at least one of Ni, Fe, Cr, Pt, B, Ta, Cu, W, Mo, and Nb.

3. The perpendicular magnetic recording medium as claimed in claim 1, wherein,
the magnetic flux control layer includes a first magnetic layer, a first non-magnetic coupling layer, and a second magnetic layer stacked on the separation layer in order, and
the first magnetic layer and the second magnetic layer are formed from a poly-crystal ferromagnetic material having an easy axis of magnetization perpendicular to the substrate, and a magnetization of the first magnetic layer and a magnetization of the second magnetic layer are aligned in a direction perpendicular to the substrate and are coupled with each other by anti-ferromagnetic coupling.

4. The perpendicular magnetic recording medium as claimed in claim 3, wherein each of the first magnetic layer and the second magnetic layer is formed from Co or a Co—X1 alloy having a hcp crystalline structure, where X1 represents at least one of Ni, Fe, Cr, Pt, B, Ta, Cu, W, Mo, and Nb.

5. The perpendicular magnetic recording medium as claimed in claim 3, wherein the first non-magnetic coupling layer of the magnetic flux control layer is formed from one of Ru, Cu, Cr, Rh, Ir, a Ru alloy, a Rh alloy, and an Ir alloy.

6. The perpendicular magnetic recording medium as claimed in claim 3, further comprising:
another soft-magnetic backup layer disposed between the separation layer and the magnetic flux control layer;
wherein
the other soft-magnetic backup layer includes a first soft magnetic layer, a second non-magnetic coupling layer, and a second soft magnetic layer stacked on the separation layer in order,
the first soft magnetic layer and the second soft magnetic layer are formed from a poly-crystal soft-magnetic material having an easy axis of magnetization in the surface thereof, and
a magnetization of the first soft magnetic layer and a magnetization of the second soft magnetic layer are aligned in an in-plane direction and are coupled with each other by anti-ferromagnetic coupling.

7. The perpendicular magnetic recording medium as claimed in claim 6, wherein the first magnetic layer of the magnetic flux control layer is formed by directly growing on a surface of the second soft magnetic layer.

8. The perpendicular magnetic recording medium as claimed in claim 6, wherein
each of the first soft magnetic layer and the second soft magnetic layer in the other soft-magnetic backup layer is formed from one of Ni, NiFe, and an alloy NiFe—X3, where X1 represents a non-magnetic material including one of Cr, Ru, Si, O, N, and SiO₂.

9. The perpendicular magnetic recording medium as claimed in claim 1, further comprising:
a third soft-magnetic layer disposed between the separation layer and the magnetic flux control layer, said third soft magnetic layer being formed from a poly-crystal soft-magnetic material having an easy axis of magnetization in an in-plane direction.

10. The perpendicular magnetic recording medium as claimed in claim 1, wherein the separation layer is formed from an amorphous non-magnetic material including at least one of Ta, Ti, C, Mo, W, Re, Os, Hf, Mg, and Pt.

11. The perpendicular magnetic recording medium as claimed in claim 1, further comprising:
an intermediate layer disposed between the magnetic flux control layer and the recording layer,
wherein
the intermediate layer has a hcp crystalline structure or a fcc crystalline structure.

12. The perpendicular magnetic recording medium as claimed in claim 11, wherein the intermediate layer is formed from a material including at least one of Ru, Pd, Pt, and a Ru—X2 alloy, where X2 represents a non-magnetic material including one of Ta, Nb, Co, Cr, Fe, Ni, Mn, O, and C.

13. The perpendicular magnetic recording medium as claimed in claim 11, wherein
the intermediate layer includes a plurality of crystal grains each growing in a direction perpendicular to the substrate, and
the crystal grains are separated from each other by a plurality of interstices or immiscible phases.

14. The perpendicular magnetic recording medium as claimed in claim 13, wherein each of the crystal grains of the intermediate layer is formed from a material including at least one of Ru and a Ru—X2 alloy, where X2 represents a non-magnetic material including one of Ta, Nb, Co, Cr, Fe, Ni, Mn, and C.

15. The perpendicular magnetic recording medium as claimed in claim 1, wherein
the recording layer is formed from a ferromagnetic material including one of Ni, Fe, a Ni-alloy, a Fe-alloy, Co, and an alloy with Co as a major component.

16. The perpendicular magnetic recording medium as claimed in claim 15, wherein
the recording layer includes a plurality of magnetic particles each formed from a ferromagnetic material including one of Ni, Fe, a Ni-alloy, a Fe-alloy, Co, and an alloy with Co as a major component, and
the magnetic particles are separated from each other by a plurality of interstices or immiscible layers.

17. The perpendicular magnetic recording medium as claimed in claim 1, wherein
the recording layer includes a first hard magnetic layer and a second hard magnetic layer stacked on the substrate in order,
the first hard magnetic layer includes a plurality of magnetic particles each formed from an alloy with Co as a major component, and the magnetic particles in the first hard magnetic layer are separated from each other by a plurality of interstices or immiscible layers, and
the second hard magnetic layer is a continuous film formed from an alloy with Co as a major component.

18. The perpendicular magnetic recording medium as claimed in claim 15, wherein the alloy with Co as a major component includes one of CoPt, CoCrTa, CoCrPt, and CoCrPt-M, where, M represents at least one of B, Mo, Nb, Ta, W, and Cu.

19. A magnetic storage device, comprising:
a recording and reproduction unit having a magnetic head; and
a perpendicular magnetic recording medium;
wherein
the perpendicular magnetic recording medium includes
a substrate;
a soft-magnetic backup layer on the substrate;
a separation layer on the soft-magnetic backup layer and formed from a non-magnetic material;
a magnetic flux control layer on the separation layer; and
a recording layer on the magnetic flux control layer, said recording layer having an easy axis of magnetization perpendicular to the surface of the substrate;
wherein
the magnetic flux control layer is formed from a poly-crystal ferromagnetic material having an easy axis of magnetization perpendicular to the surface of the substrate.
